(19) United States
(12) Patent Application Publication
(10) Pub. No.: US 2026/0212095 A1
(43) Pub. Date: Jul. 23, 2026

(54) METHOD FOR DESIGNING PRINTED CIRCUIT BOARD AND PRINTED CIRCUIT BOARD DESIGN SYSTEM

(71) Applicant: SAMSUNG ELECTRONICS CO., LTD., Suwon-si (KR)

(72) Inventors: Taehee KIM, Suwon-si (KR); Doyun KIM, Suwon-si (KR); Jaemin PARK, Suwon-si (KR); Taejin PAIK, Suwon-si (KR); Daniel Hyunsuk JUNG, Suwon-si (KR)

(73) Assignee: SAMSUNG ELECTRONICS CO., LTD., Suwon-si (KR)

(21) Appl. No.: 19/388,251

(22) Filed: Nov. 13, 2025

(30) Foreign Application Priority Data
Jan. 17, 2025 (KR) 10-2025-0007279

(51) Int. Cl. G06F 30/31; G06F 115/12

(52) U.S. Cl. CPC G06F 30/31; G06F 2115/12

(57) ABSTRACT

A printed circuit board design system includes one or more processors including processing circuitry and memory storing instructions. The instructions, when executed by the one or more processors individually or collectively, cause the printed circuit board design system to generate a canvas based on a length of a preset target trace, determine an arbitrary start point and an arbitrary end point within the canvas, randomly place a first obstacle having a first size within the canvas, randomly place a second obstacle having a second size within the canvas, generate a reference trace from the arbitrary start point to the arbitrary end point that avoids the first obstacle, generate at least one variant trace from the arbitrary start point to the arbitrary end point that avoids the second obstacle, and generate a candidate trace set including the reference trace and the at least one variant trace.

### CROSS-REFERENCE TO RELATED APPLICATIONS

This application claims priority under 35 U.S.C. § 119 to Korean Patent Application No. 10-2025-0007279, filed on Jan. 17, 2025, in the Korean Patent Office, the disclosure of which is incorporated by reference herein in its entirety.

### BACKGROUND

### 1. Field

The present disclosure relates generally to semiconductors, and more particularly, to a printed circuit board design device and a printed circuit board design method.

### 2. Description of Related Art

In the semiconductor field, routing may refer to a process of laying out wiring and/or calculating paths for wiring within a multi-layered semiconductor package.

These routing tasks may be need to be performed by design experts using specialized electronic design automation (EDA) tools and/or may require a considerable amount of time to perform. Accordingly, artificial intelligence (AI) technologies, such as, but not limited to, artificial neural network models, may be used to automate and/or attempt to improve the efficiency of these routing tasks.

The artificial neural network models may need to be trained using training data in order to effectively utilize the artificial neural network models. However, generating such training data may pose a challenge, as the generation of the training data may require a significant amount of resources (e.g., time, effort, processing power, memory footprint).

### SUMMARY

One or more example embodiments of the present disclosure provide a printed circuit board design system and a printed circuit board design method for generating various trace geometries within a printed circuit board (PCB).

Further, one or more example embodiments of the present disclosure provide a printed circuit board design system and a printed circuit board design method for generating a PCB model in which various geometries of traces are arranged.

According to an aspect of the present disclosure, a printed circuit board design system includes one or more processors including processing circuitry and memory storing instructions. The instructions, when executed by the one or more processors individually or collectively, cause the printed circuit board design system to generate a canvas based on a length of a preset target trace, determine an arbitrary start point and an arbitrary end point within the canvas, randomly place a first obstacle having a first size within the canvas, randomly place a second obstacle having a second size within the canvas, generate a reference trace from the arbitrary start point to the arbitrary end point that avoids the first obstacle, generate at least one variant trace from the arbitrary start point to the arbitrary end point that avoids the second obstacle, and generate a candidate trace set including the reference trace and the at least one variant trace. The second size is smaller than the first size.

According to an aspect of the present disclosure, a method for designing a printed circuit board includes generating a candidate trace set including a reference trace and at least one variant trace corresponding to the reference trace, determining a target number of candidate trace sets based on a topology of a structure of the printed circuit board, determining whether a number of generated candidate trace sets satisfies the target number of candidate trace sets, and, based on determining that the number of generated candidate trace sets satisfies the target number of candidate trace sets, generating routing data for the printed circuit board. The routing data includes the generated candidate trace sets to be disposed on the printed circuit board. The printed circuit board includes at least one layer.

According to an aspect of the present disclosure, a method for designing a printed circuit board includes generating a canvas based on a length of a preset target trace, setting an arbitrary start point and an arbitrary end point within the canvas, randomly placing a first obstacle having a first size within the canvas, generating a reference trace from the arbitrary start point to the arbitrary end point that avoids the first obstacle, randomly placing a second obstacle having a second size within the canvas, generating at least one variant trace from the arbitrary start point to the arbitrary end point that avoids the second obstacle, and generating a candidate trace set including the reference trace and at least one variant trace. The second size is smaller than the first size.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram illustrating a printed circuit board (PCB) design system, according to an embodiment;

FIG. 2 is a drawing illustrating operation of a PCB design tool, according to an embodiment;

FIG. 3 is a drawing illustrating a printed circuit board design method, according to an embodiment;

FIG. 4 is a diagram illustrating a method for generating a candidate trace set according to FIG. 3, according to an embodiment;

FIG. 5 is a drawing exemplarily illustrating a canvas, according to an embodiment;

FIG. 6 is a diagram illustrating a method for generating a candidate trace set, according to an embodiment;

FIG. 7 is a drawing exemplarily illustrating a PCB model, according to an embodiment; and

FIG. 8 is a block diagram illustrating a printed circuit board test system, according to an embodiment.

### DETAILED DESCRIPTION

In the following detailed description, only certain exemplary embodiments of the present disclosure have been shown and described, simply by way of illustration. It may be apparent to those skilled in the art that the described embodiments may be modified in various different ways, all without departing from the spirit or scope of the present disclosure. Accordingly, the drawings and description are to be regarded as illustrative in nature and not restrictive.

Like reference numerals may designate like elements throughout the specification. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. In the flowcharts described with reference to the drawings, an operation order may be changed, several operations may be merged or some operations may be divided and/or a specific operation may not be performed. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Further, expressions described as a singular form may be interpreted as singular or plural unless explicit expression such as, but not limited to, “one” or “single” is used. Terms including an ordinal number, such as, but not limited to, first and second, may be used for describing various constituent elements, but the constituent elements may not be limited by the terms. The terms may be used only to discriminate one constituent element from another constituent element.

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “upper,” “middle”, “lower”, or the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, or the like may be used to distinguish components from each other and do not limit the present disclosure. For example, the terms “first”, “second”, “third”, or the like may not necessarily involve an order or a numerical meaning of any form.

As used herein, when an element or layer is referred to as “covering”, “overlapping”, or “surrounding” another element or layer, the element or layer may cover at least a portion of the other element or layer, where the portion may include a fraction of the other element or may include an entirety of the other element. Similarly, when an element or layer is referred to as “penetrating” another element or layer, the element or layer may penetrate at least a portion of the other element or layer, where the portion may include a fraction of the other element or may include an entire dimension (e.g., length, width, depth) of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

The embodiments herein may be described and illustrated in terms of blocks, as shown in the drawings, which carry out a described function or functions. These blocks, which may be referred to herein as units or modules or the like, or by names such as, but not limited to, device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

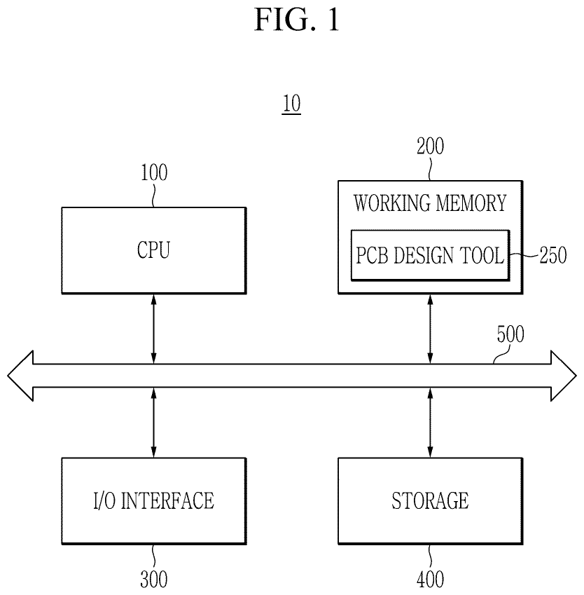

FIG. 1 is a block diagram illustrating a computing system for printed circuit board design, according to an embodiment.

Referring to FIG. 1, a computing system 10 for designing a printed circuit board (PCB) is illustrated. As shown in FIG. 1, the computing system 10 may include a central processing unit (CPU) 100, a working memory (or memory) 200, an input/output (I/O) interface 300, a storage device 400, and a system bus 500.

In an embodiment, the computing system 10 may be and/or may include a dedicated device for designing semiconductor devices and/or a computing device for driving various design tools.

The CPU 100 may control an overall operation of each component of the computing system 10. The CPU 100 may be implemented as at least one of various processing units such as, but not limited to, a general purpose processor, an application processor (AP), a graphics processing unit (GPU), a digital signal processor (DSP), a field programmable gate array (FPGA), an application-specific integrated circuit (ASIC), a neural processing unit (NPU), a hardware accelerator, a machine learning accelerator, or the like. The CPU 100 may execute at least one program or instruction stored in the working memory 200. For example, the CPU 100 may perform a method, according to an embodiment of the present disclosure, by executing at least one instruction stored in the working memory 200.

If the method, according to an embodiment of the present disclosure, includes a plurality of operations, the plurality of operations may be performed by one processor (e.g., the CPU 100), or may be performed by a plurality of processors (e.g., two or more CPU 100). For example, if a first operation, a second operation, and a third operation are performed by the method, according to an embodiment, the first operation, the second operation, and the third operation may all be performed by a first processor. Alternatively or additionally, the first operation and the second operation may be performed by the first processor (e.g., a general-purpose processor), and the third operation may be performed by a second processor (e.g., an artificial intelligence-only processor).

The CPU 100 may execute software (e.g., application programs, operating system, device drivers) to be performed in the computing system 10. In an embodiment, the CPU 100 may execute an operating system (OS) loaded into working memory 200. The CPU 100 may execute various application programs (APs) and/or design tools that may be driven by the OS. For example, the CPU 100 may drive a PCB design tool 250 loaded into the working memory 200.

The OS and/or application programs may be loaded into the working memory 200. For example, when booting the computing system 10, an OS image that may be stored in a storage device 400 may be loaded into the working memory 200 based on the boot sequence. I/O operations of the computing system 10 may be supported by an operating system (OS). In an embodiment, an application may be loaded into working memory 200. The working memory 200 may be and/or may include a volatile memory such as, but not limited to, static random access memory (SRAM) or dynamic random access memory (DRAM), or a nonvolatile memory such as, but not limited to, phase change random access memory (PRAM), magnetic random access memory (MRAM), resistive random access memory (ReRAM), ferroelectric random access memory (FeRAM), or flash memory.

The PCB design tool 250 may generate traces having various geometries.

A trace may refer to a conductive path that may carry electrical signals within a PCB. For example, traces may represent lines along which metal wiring may be formed on the PCB. The PCB design tool 250 may generate various geometries of traces that may be disposed within the PCB and/or may place components based on the generated trace geometries.

In an embodiment, the PCB may include at least one layer. Hereinafter, a layer on which a trace is placed may be referred to as a trace layer, and a layer connected to a ground voltage and/or a power voltage may referred to as a reference layer.

The PCB design tool 250 may generate a PCB model having various trace geometries. A PCB model may include at least one layer. For example, a PCB design tool 250 may generate a plurality of candidate trace sets that may be applied to a PCB model. A set of candidate traces may include one reference trace and at least one variant trace corresponding to the reference trace. Each of the plurality of candidate trace sets may be placed in at least one trace layer. A reference trace may refer to a trace connected between an arbitrary start point and an arbitrary end point. A variant trace may refer to a trace partially modified from the reference trace.

In an embodiment, the PCB design tool 250 may generate a PCB model based on PCB configuration information. PCB configuration information may be a necessary condition for generating a PCB model. For example, the PCB design tool 250 may read PCB configuration information stored in a storage device 400 and/or may receive PCB configuration information from an external source through the I/O interface 300.

In an embodiment, the PCB configuration information may include trace condition information, topology information, physical property information, and stackup distribution information. However, embodiments of the present disclosure are not limited thereto, and the PCB configuration information may include additional information for generating the PCB model.

The trace condition information may refer to data relating to traces formed within the PCB. For example, the trace condition information may include the total number of layers included in the PCB, the length of traces disposed on a single layer, and/or the number of variant traces included in the candidate trace set.

In an embodiment, the trace condition information may be in the form of a range composed of multiple values rather than a single value.

The topology information may refer to data related to the PCB structure. For example, a topology may include data related to vias formed within a PCB. In an embodiment, the number of trace layers included in the PCB may be determined based on the total number of layers included in the PCB and the number of vias. For example, the PCB design tool 250 may determine the number of candidate trace sets to generate based on the topology.

The physical property information may refer to data related to the materials included in the PCB. For example, the physical property information may include data on dielectric properties disposed between at least one layer, and/or data on a thickness between at least one layer. For example, the PCB design tool 250 may generate a PCB model in which each of a plurality of candidate trace sets is placed on at least one trace layer based on the physical property information, and each of at least one trace layer and a reference layer may be spaced apart with preset thicknesses.

The stackup distribution information may include data for at least one layer within a PCB. For example, a stackup distribution may include data related to the position of the trace layer and the position of the reference layer.

In an embodiment, the PCB design tool 250 may perform the operations of generating a plurality of candidate trace sets and placing each of the plurality of candidate trace sets into a trace layer. For example, a PCB design tool 250 may generate the plurality of candidate trace sets using a shortest path search algorithm, such as, but not limited to, a graph traversal algorithm, a pathfinding algorithm, an A* algorithm, or the like.

The I/O interface 300 may receive user input from a user interface device and control the output of the computing system 10. For example, the I/O interface 300 may be connected to an input device such as, but not limited to, a keyboard, mouse, or touchpad. The computing system 10 may receive configuration information of a semiconductor device, such as, but not limited to, trace conditions, topology, physical property information, and stack-up distribution, through an I/O interface 300. For example, the I/O interface 300 may be connected to an output device such as, but not limited to, a monitor. The computing system 10 may output the progress and processing results of the design operation of the computing system 10 through the I/O interface 300.

The storage device 400 may store application programs, operating system (OS) images, and/or data. The storage device 400 may be and/or may include a memory card (e.g., multimedia card (MMC), embedded MMC (eMMC), secure digital (SD) card, micro SD (MicroSD) card, or the like), a hard disk drive (HDD). In an embodiment, the storage device 400 may be and/or may include NAND-type Flash memory, PRAM, MRAM, ReRAM, FeRAM, or the like.

The system bus 500 may be and/or may include an interconnector for providing a network within the computing system 10. The CPU 100, the working memory 200, the I/O interface 300, and the storage device 400 may be electrically and/or communicatively connected and may exchange data with each other through the system bus 500.

The number and arrangement of components of the computing system 10 shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Alternatively or additionally, a set (one or more) of components shown in FIG. 1 may be integrated with each other, and/or may be implemented as an integrated circuit, as software, and/or a combination of circuits and software.

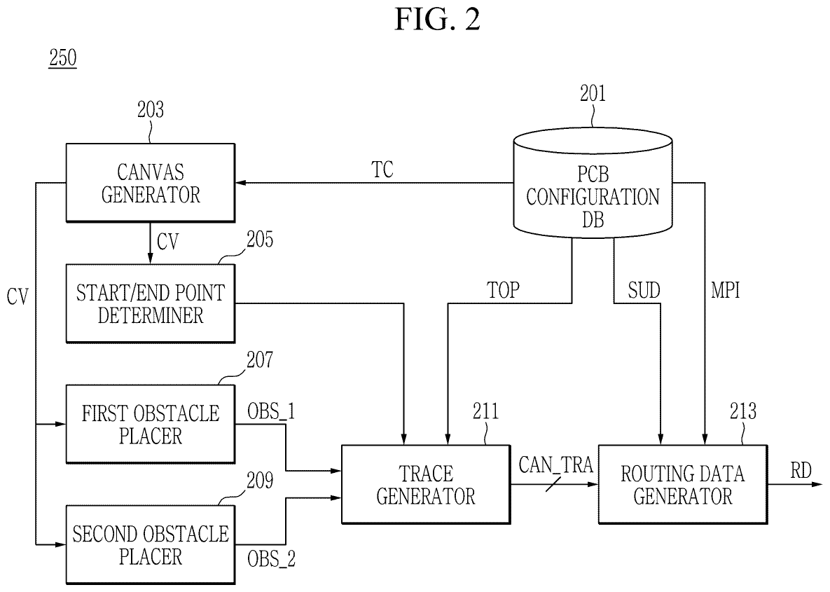

FIG. 2 is a drawing illustrating operation of the PCB design tool 250, according to an embodiment.

Referring to FIG. 2, the PCB design tool 250 may include a PCB configuration database (DB) 201, a canvas generator 203, a start/end point determiner 205, a first obstacle placer 207, a second obstacle placer 209, a trace generator 211, and a routing data generator 213.

In an embodiment, the PCB design tool 250 may be physically implemented by analog and/or digital circuits including one or more of a logic gate, an integrated circuit, a microprocessor, a microcontroller, a memory circuit, a passive electronic component, an active electronic component, an optical component, and the like. For example, an FPGA may be used to implement custom logic that may include the functionality of the PCB design tool 250. As another example, a processor in combination with a memory may be used to execute one or more instructions to perform the functionality of the PCB design tool 250. Alternatively or additionally, at least a portion of the functionality of PCB design tool 250 may be incorporated into CPU 100 of the computing system 10 and/or implemented as instructions to be executed by the CPU 100 and stored in the working memory 200 or the storage device 400. That is, the CPU 100 of FIG. 1 may perform PCB design operations by executing the PCB design tool 250.

The canvas generator 203 may extract a trace condition TC from the PCB configuration database 201. Trace conditions may include data related to the traces formed within the PCB. For example, the trace condition TC may include data related to the length of the trace. The PCB configuration database 201 may be included in the storage device 400 or may be included in an external device and accessed via the I/O interface 300.

The canvas generator 203 may generate a canvas CV based on a trace condition TC. In an embodiment, the canvas generator 203 may generate a canvas CV based on the length of the trace indicated by the trace condition TC. For example, the canvas generator 203 may determine the size of the canvas based on a preset formula. The preset formula may be a linear function that may dictate the relationship between the length of the trace and the size of the canvas. The canvas generator 203 may transfer the generated canvas CV to the start/end point determiner 205, the first obstacle placer 207, and the second obstacle placer 209.

The start/end point determiner 205 may determine the positions of the start point and the end point within the canvas CV based on the canvas CV received from the canvas generator 203. In an embodiment, the start/end point determiner 205 may select any two positions within the canvas, determine one position of the two positions as the start point, and determine the other (remaining) position as the end point.

The first obstacle placer 207 may randomly place a plurality of first obstacles within a canvas CV. For example, the first obstacle placer 207 may generate first obstacle data OBS_1 that may include the positions of each of a plurality of first obstacles. In an embodiment, the first obstacle may have a preset first size. For example, the first size may be less than 20 micrometer (μm) in diameter. The first obstacle may have a square shape. However, embodiments of the present disclosure are not limited thereto, and the first obstacle may have any size and/or any shape.

The second obstacle placer 209 may randomly place a plurality of second obstacles within a canvas CV. For example, the second obstacle placer 209 may generate second obstacle data OBS_2 that may include the positions of each of a plurality of second obstacles. In an embodiment, the second obstacle may have a second size that may be smaller than the first size. For example, the second size may be less than 1 μm in diameter. The second obstacle may have a square shape. However, embodiments of the present disclosure are not limited thereto, and the second obstacle may have any size and/or any shape.

The trace generator 211 may receive the positions of the start point and the end point within the canvas CV from the start/end point determiner 205.

In an embodiment, the trace generator 211 may receive the first obstacle data OBS_1 from the first obstacle placer 207. The first obstacle data OBS_1 may include positions of first obstacles randomly placed in the canvas CV by the first obstacle placer 207. The trace generator 211 may generate a reference trace from the start point to the end point provided by the start/end point determiner 205, based on a path search algorithm (e.g., the A* algorithm). The reference trace may be non-overlapping with each of the plurality of first obstacles. That is, the reference trace may avoid each of the plurality of first obstacles.

In an embodiment, the trace generator 211 may generate a reference trace using the A* algorithm. The A* algorithm may refer to an algorithm for efficiently searching for the shortest path from the start point to the end point. For example, the A* algorithm may use a cost function to find the shortest path. The cost function may be represented as an equation similar to Equation 1.

$$f ( n ) = g ( n ) + h ( n ) \qquad [ Equation 1 ]$$

Referring to Equation 1, g(n) may represent a function of the actual cost from the start point to the end point, and h(n) may represent a function of the estimated cost from the current point to the end point. In an embodiment, h(n) may be and/or may include a heuristic function based on estimates. The trace generator 211 may determine a path, as a reference trace, that may satisfy the trace conditions from among a plurality of paths and that has a minimum value of f(n) from among the plurality of paths.

A reference trace may include a plurality of unit reference traces. A unit reference trace may be a straight line path connecting any point of the reference trace to any other point in the reference trace. The trace length of the reference trace may be the sum of the lengths of each of the plurality of unit reference traces. That is, the trace generator 211 may determine, as a reference trace, a path that satisfies a trace length condition from among a plurality of paths and having a minimum value of f(n).

The trace generator 211 may generate coordinate data of both ends (e.g., the start point and the end point) of each unit reference trace constituting the reference trace. For example, the ends of a unit reference trace may correspond to bend points of the reference trace.

In an embodiment, the trace generator 211 may receive the second obstacle data OBS_2 from the second obstacle placer 209. The second obstacle data OBS_2 may include randomly placed second obstacles.

The trace generator 211 may generate at least one variant trace from a start point to an end point based on a path searching algorithm (e.g., the A* algorithm). At least one of the variant traces may be non-overlapping with each of the plurality of second obstacles. That is, at least one variant trace may avoid each of the plurality of second obstacles. Each of the at least one variant trace may be disposed in proximity to the reference trace.

In an embodiment, the trace generator 211 may generate the at least one variant trace using the A* algorithm using a cost function that accounts for a distance from the at least one variant trace to the reference trace as an additional heuristic cost. The cost function may be represented as an equation similar to Equation 2.

$$f ( n ) = g ( n ) + {h}^{′} ( n ) \qquad [ Equation 2 ]$$

$${h}^{′} ( n ) = h ( n ) + d ( n )$$

Referring to Equation 2, d(n) may represent a function of the distance from the at least one variant trace to the reference trace.

The trace generator 211 may determine the path where the value of f(n) is minimized as a variant trace. That is, the trace generator 211 may determine, as a variant trace, a path that satisfies trace conditions among a plurality of paths located within a distance threshold from the reference trace from among a plurality of paths from the start point to the end point. The threshold distance may be a preset or predetermined value. A variant trace may include the plurality of unit variant traces. A unit variant trace may be a straight line path connecting any point in the variant trace to any other point in the variant trace.

The trace generator 211 may generate coordinate data of both ends (e.g., a start point and an end point) of each unit variant trace constituting the variant trace. For example, the ends of a unit variant trace may be the bend points of the variant trace.

However, embodiments of the present disclosure are not limited thereto, and the trace generator 211 may generate a trace using an appropriate algorithm such as, but not limited to, Dijkstra's algorithm, Bellman-Ford algorithm, Floyd-Warshall algorithm, or the like.

The trace generator 211 may extract a topology TOP from the PCB configuration database 201. The topology TOP may include data about the PCB structure. In an embodiment, the topology TOP may include data related to vias formed within the PCB. For example, if the topology TOP indicates a point-to-point (1P1P) PCB structure, the PCB may include two (2) sets of vias and three (3) trace sets. However, embodiments of the present disclosure are not limited thereto, and depending on the setting, the structure of the 1P1P PCB may include a different number of via sets and/or a different number of trace sets.

In an embodiment, the trace generator 211 may determine the number of candidate trace sets based on the topology TOP. A candidate trace set may include a reference trace and at least one variant trace corresponding to the reference trace.

In an embodiment, the trace generator 211 may generate a plurality of candidate trace set data CAN_TRA based on the topology TOP. The candidate trace set data CAN_TRA may include data for a reference trace and at least one variant trace corresponding to the reference trace. For example, the candidate trace set data CAN_TRA may include coordinate data of the ends of a unit reference trace and coordinate data of the ends of a unit variant trace.

For example, if the topology TOP indicates the 1P1P PCB structure, the trace generator 211 may determine the number of the plurality of candidate trace sets to be three (3). The trace generator 211 may generate a first candidate trace set including a first reference trace and at least one first variant trace corresponding to the first reference trace, a second candidate trace set including a second reference trace and at least one second variant trace corresponding to the second reference trace, and a third candidate trace set including a third reference trace and at least one third variant trace corresponding to the third reference trace.

Although the description with reference of FIG. 2 describes that the trace generator 211 generates one (1) reference trace and generates at least one variant trace corresponding to the generated reference trace, embodiments of the present disclosure are not limited thereto. For example, the trace generator 211 may generate a plurality of reference traces and generate at least one variant trace corresponding to each of the plurality of reference traces.

The routing data generator 213 may extract physical property information MPI and/or stackup distribution SUD from the PCB configuration database 201. The physical property information MPI may include data about the materials contained in the PCB. For example, the physical property information MPI may include data on dielectric properties disposed between at least one layer, and data on the thickness between at least one layer. The stackup distribution SUD may include data for at least one layer within a PCB. For example, a stackup distribution SUD may include data related to the position of the trace layer and the position of the reference layer.

In an embodiment, the routing data generator 213 may determine the structure of the PCB model based on the physical property information MPI and/or the stackup distribution SUD. For example, the routing data generator 213 may determine the thickness between at least one layer included in the PCB model, the arrangement order of each of the at least one layer, or the like.

The routing data generator 213 may receive the plurality of candidate trace set data CAN_TRA from the trace generator 211. In an embodiment, the routing data generator 213 may perform scaling based on the plurality of candidate trace set data CAN_TRA, the trace condition TC, the topology TOP, the physical property information MPI, and the stackup distribution SUD. For example, the routing data generator 213 may scale the lengths of the reference traces and the variant traces included in each of the plurality of candidate trace sets so that the lengths of the reference traces and the variant traces correspond to the target trace lengths. For example, the routing data generator 213 may scale the lengths of the reference trace and the variant trace so that the portion of the trace extending parallel to the first direction of the canvas and the portion of the trace extending parallel to the second direction perpendicular to the first direction have the same ratio. Thereby, the lengths of the reference trace and the variant trace may satisfy the lengths of the traces set in the trace condition TC.

As another example, the routing data generator 213 may adjust the spacing between the reference trace and the variant trace included in each of the plurality of candidate trace sets. As the spacing between traces gets smaller, interference between signals transmitted through the traces may occur. To prevent signal interference, for example, the routing data generator 213 may adjust, based on preset criteria, a distance between a trace transmitting a data strobe signal and a trace transmitting an individual data signal, a distance between a trace transmitting the data strobe signal and a trace transmitting an inverted data strobe signal, and/or distances between traces transmitting data signals.

The routing data generator 213 may generate routing data RD based on at least one scaled reference trace and at least one variant trace. The at least one reference trace and the at least one variant trace may be scaled based on a structure of a PCB model determined using the physical property information MPI and the stack-up distribution SUD, and based on a plurality of candidate trace set data CAN_TRA. That is, the routing data RD may be determined based on a combination of the structure of the PCB model and data of the plurality of scaled candidate trace sets. For example, routing data RD may be and/or may include a 3-dimensional (3D) representation of the plurality of candidate trace sets on the structure of a PCB model.

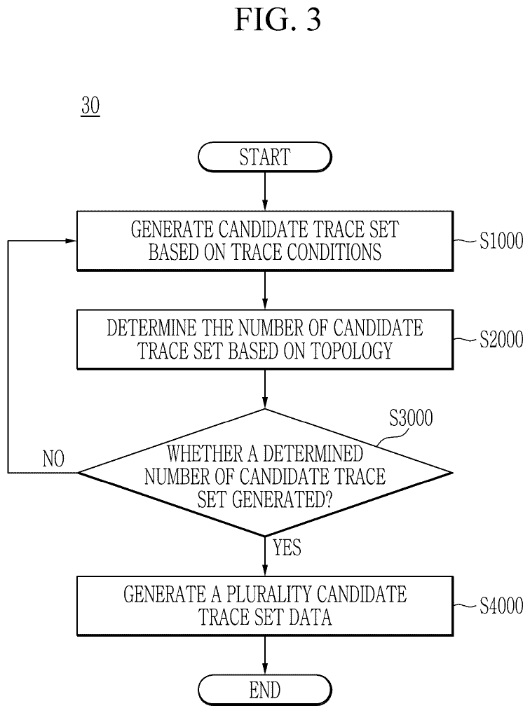

FIG. 3 is a drawing illustrating a printed circuit board design method, according to an embodiment. Referring to FIG. 3, the printed circuit board design method 30 that implements one or more aspects of the present disclosure is illustrated. In some embodiments, at least a portion of the printed circuit board design method 30 may be performed by a device or system (e.g., the computing system 10). Alternatively or additionally, another computing device (e.g., a server, a personal computer (PC), a laptop, a smartphone, or the like) that includes the PCB design tool 250 may perform at least a portion of the printed circuit board design method 30. For example, in some embodiments, the device and the other computing device may perform the printed circuit board design method 30 in conjunction. That is, the device may perform a portion of the printed circuit board design method 30 and a remaining portion of the printed circuit board design method 30 may be performed by one or more other computing devices.

As shown in FIG. 3, the trace generator 211 may generate a candidate trace set based on a trace condition TC (operation S1000).

The trace generator 211 may determine the number of candidate trace sets based on the topology TOP (operation S2000). Hereinafter, the number of determined candidate trace sets may be referred to as the target number.

The trace generator 211 may determine whether a determined number of candidate trace sets have been generated (operation S3000).

Based on a determination that the target number of candidate trace sets have been generated (YES at operation S3000), the trace generator 211 may generate the plurality of candidate trace set data CAN_TRA (operation S4000). The trace generator 211 may transmit (or provide) the plurality of candidate trace set data CAN_TRA to the routing data generator 213.

Based on a determination that the target number of candidate trace sets have not been generated (NO at operation S3000), the printed circuit board design method 30 may return to operation S1000.

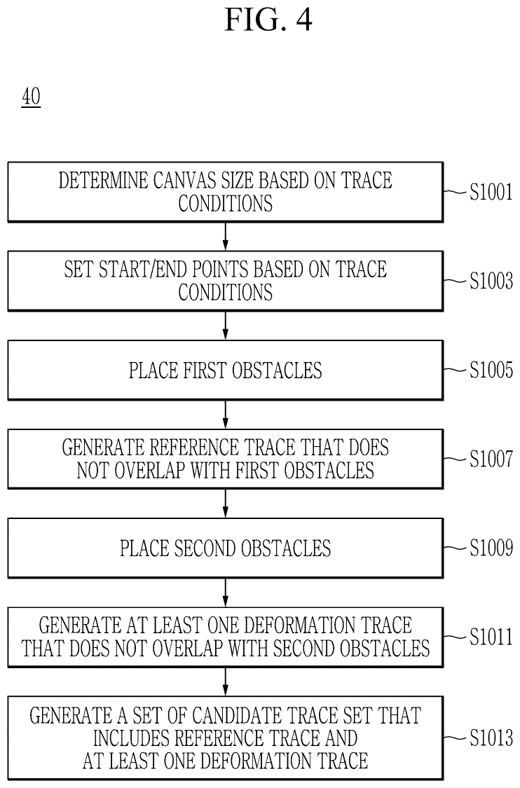

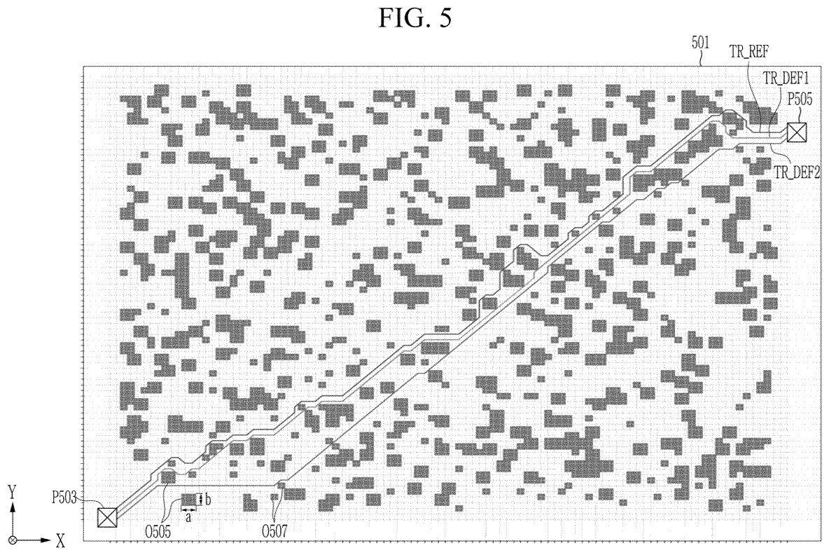

FIG. 4 is a diagram illustrating a method for generating a candidate trace set according to FIG. 3, according to an embodiment. FIG. 5 is a drawing exemplarily illustrating a canvas, according to an embodiment.

Referring to FIG. 4, the method 40 that implements one or more aspects of the present disclosure is illustrated. In some embodiments, at least a portion of the method 40 may be performed by a device or system (e.g., the computing system 10). Alternatively or additionally, another computing device (e.g., a server, a PC, a laptop, a smartphone, or the like) that includes the PCB design tool 250 may perform at least a portion of the method 40. For example, in some embodiments, the device and the other computing device may perform the method 40 in conjunction. That is, the device may perform a portion of the method 40 and a remaining portion of the method 40 may be performed by one or more other computing devices.

The operations of the method 40 for generating the candidate trace set are described with reference to FIGS. 4 and 5 together.

The canvas generator 203 may determine the canvas size based on the trace condition TC (operation S1001).

As shown in FIG. 5, the canvas generator 203 may determine the size of the canvas 501 based on the trace condition TC. For example, a trace condition TC may include a target trace length to be generated.

The start/end point determiner 205 may set the start point and the end point based on the trace condition TC (operation S1003).

As shown in FIG. 5, the start/end point determiner 205 may set a start point P503 and an end point P505 within the canvas 501. For example, the start/end point determiner 205 may set the start point P503 and the end point P505 positioned at corners facing each other within the canvas 501. However, embodiments of the present disclosure are not limited thereto, and the start/end point determiner 205 may set the start point P503 and the end point P505 so that the start point P503 and the end point P505 are placed at any position within the canvas 501 that may satisfy the trace condition TC.

The first obstacle placer 207 may place a plurality of first obstacles (operation S1005).

As shown in FIG. 5, the first obstacle placer 207 may place the first obstacle 0505 within the canvas 501. The first obstacle 0505 may be randomly placed within the canvas 501. The first obstacle 0505 may have a size greater than or equal to the preset first size. For example, the first size may be the size of a rectangle having a first length in the x-axis direction (e.g., first length a) and a second length in the y-axis direction (e.g., second length b).

The trace generator 211 may generate a reference trace that may not overlap with the plurality of first obstacles (operation S1007). That is, the reference trace may avoid each of the plurality of first obstacles.

As shown in FIG. 5, the trace generator 211 may generate a reference trace TR_REF connecting the start point P503 to the end point P505. The trace generator 211 may determine a path, which does not overlap with the plurality of first obstacles 0505, as the reference trace TR_REF. For example, the trace generator 211 may generate the reference trace TR_REF using a path search algorithm (e.g., the A* algorithm).

The second obstacle placer 209 may place a plurality of second obstacles (operation S1009).

As shown in FIG. 5, the second obstacle placer 209 may place the second obstacle 0507 within the canvas 501. The second obstacle 0507 may be randomly placed within the canvas 501. The second obstacle 0507 may have a size that is less than the preset first size.

The trace generator 211 may generate at least one variant trace that does not overlap with the second obstacle (operation S1011). That is, the at least one variant trace may avoid each of the plurality of second obstacles.

As shown in FIG. 5, the trace generator 211 may generate at least one variant trace (e.g., a first variant trace TR_DEF1 and a second variant trace TR_DEF2) connecting the start point P503 to the end point P505. The trace generator 211 may determine a path, which does not overlap with the plurality of second obstacles 0507, as a variant trace. For example, the trace generator 211 may generate first and second variant traces TR_DEF1 and TR_DEF2 using a path search algorithm (e.g., the A* algorithm).

Although FIG. 5 depicts the trace generator 211 as generating two (2) variant traces (e.g., the first and second variant traces TR_DEF1 and TR_DEF2), embodiments of the present disclosure are not limited thereto. For example, the trace generator 211 may generate three (3) or more variant traces.

The trace generator 211 may generate a candidate trace set including the reference trace TR_REF and the at least one variant trace TR_DEF1 and TR_DEF2 (operation S1013).

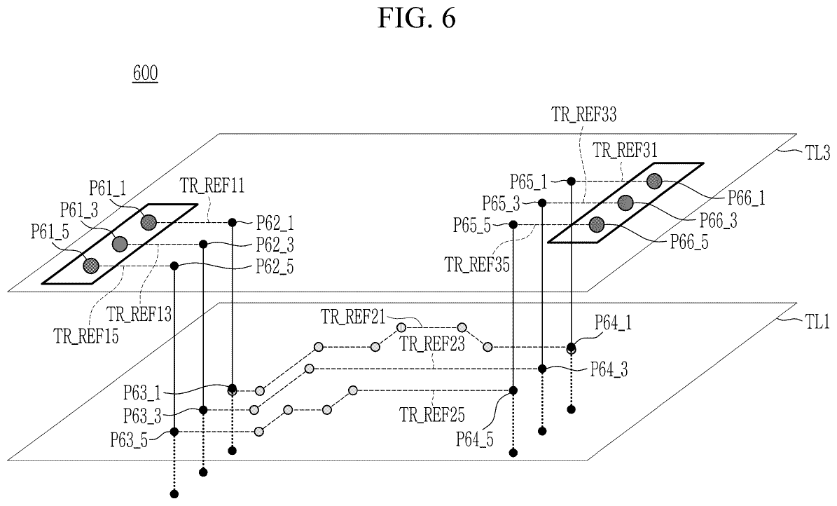

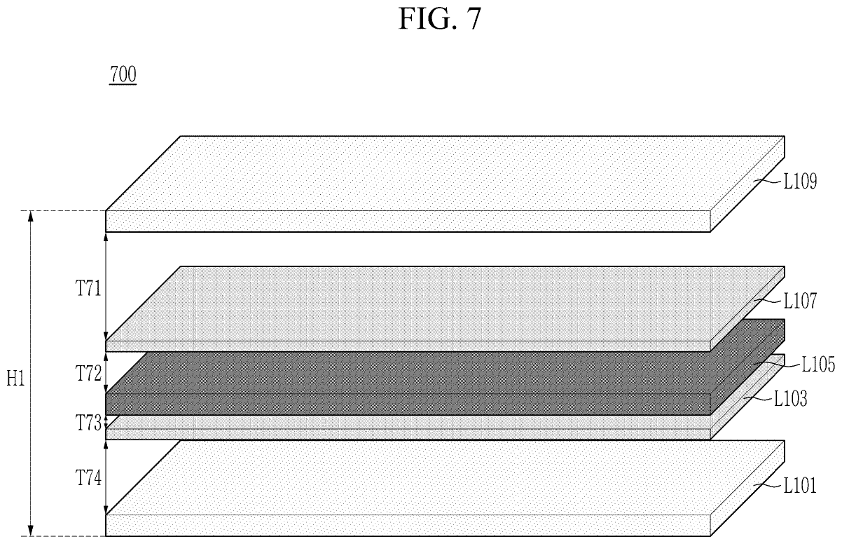

FIG. 6 is a diagram illustrating a method for generating a candidate trace set according to FIG. 3, according to an embodiment. FIG. 7 is a drawing exemplarily illustrating a PCB model, according to an embodiment.

Referring to FIG. 4, the method 600 that implements one or more aspects of the present disclosure is illustrated. In some embodiments, at least a portion of the method 600 may be performed by a device or system (e.g., the computing system 10). Alternatively or additionally, another computing device (e.g., a server, a PC, a laptop, a smartphone, or the like) that includes the PCB design tool 250 may perform at least a portion of the method 600. For example, in some embodiments, the device and the other computing device may perform the method 600 in conjunction. That is, the device may perform a portion of the method 600 and a remaining portion of the method 600 may be performed by one or more other computing devices.

The trace generator 211 may generate a candidate trace set connecting first start points (e.g., a first start point P61_1, a second start point P61_3, and a third start point P61_5) with corresponding first end points (e.g., a first end point P62_1, a second end point P62_3, and a third end point P62_5) based on the trace condition TC. For example, the trace generator 211 may generate a first reference trace TR_REF11 connecting the first start point P61_1 with the first end point P62_1, a second reference trace TR_REF13 connecting the second start point P61_3 with the second end point P62_3, a third reference trace TR_REF15 connecting the third start point P61_5 with the third end point P62_5. For convenience of explanation, only the reference traces TR_REF11, TR_REF13, TR_REF15 included in the candidate trace set are illustrated in FIG. 6.

The trace generator 211 may determine the number of vias and the positions of the vias based on the topology TOP. For example, if the topology TOP indicates a 1P1P structure, the trace generator 211 may generate three (3) candidate trace sets.

The trace generator 211 may generate a candidate trace set connecting second start points (e.g., a first start point P63_1, a second start point P63_3, and a third start point P63_5) with corresponding second end points (e.g., a first end point P64_1, a second end point P64_3, a third end point P64_5). For example, the trace generator 211 may generate a first reference trace TR_REF21 connecting the first start point P63_1 with the first end point P64_1, a second reference trace TR_REF23 connecting the second start point P63_3 with the second end point P64_3, a third reference trace TR_REF25 connecting the third start point P63_5 with the third end point P64_5. For convenience of explanation, only the reference traces TR_REF21, TR_REF23, TR_REF25 included in the candidate trace set are illustrated in FIG. 6.

Additionally, the trace generator 211 may generate a set of candidate traces connecting third start points (e.g., a first start point P65_1, a second start point P65_3, and a third start point P65_5) with corresponding third end points (e.g., a first end point P66_1, a second end point P66_3, and a third end point P66_5). For example, the trace generator 211 may generate a first reference trace TR_REF31 connecting the first start point P65_1 with the first end point P66_1, a second reference trace TR_REF33 connecting the second start point P65_3 with the second end point P66_3, a third reference trace TR_REF35 connecting the third start point P65_5 with the third end point P66_5. For convenience of explanation, only the reference traces TR_REF31, TR_REF33, TR_REF35 included in the candidate trace set are illustrated in FIG. 6.

Since the topology TOP includes information about the position of the via, the trace generator 211 may determine that the first to third second start points P63_1 to P63_5 are to be located on the first layer TL1 extending in the second direction (e.g., −y direction) from the first to third first end points P62_1 to P62_5 of the first candidate trace set, based on the topology TOP. Similarly, the trace generator 211 may determine the first to third third start points P65_1 to P65_5 are to be located on a second layer TL3 extending in a second direction (e.g., +y direction) from the first to third first end points P64_1 to P64_5 of a second candidate trace set based on the topology TOP.

The trace generator 211 may generate a first candidate trace set and the plurality of candidate trace set data CAN_TRA. The trace generator 211 may transmit the plurality of candidate trace set data CAN_TRA to the routing data generator 213.

The routing data generator 213 may place each of the plurality of candidate trace sets in a corresponding layer based on the plurality of candidate trace set data CAN_TRA, trace condition TC, topology TOP, physical property information MPI, and stackup distribution SUD. In addition, the routing data generator 213 may generate a PCB model by appropriately stacking layers in which the plurality of candidate trace sets are disposed, and generate routing data RD for the PCB model.

The routing data generator 213 may determine the total number of layers included in the PCB model based on the trace condition TC. For example, a PCB model may include five (5) layers. Referring to FIG. 7, the PCB model 700 may include the plurality of layers (e.g., a first layer L101, a second layer L103, a third layer L105, a fourth layer L107, and a fifth layer L109). As shown in FIG. 7, the first layer L101, the second layer L103, the third layer L105, the fourth layer L107, and the fifth layer L109 may be sequentially stacked.

The routing data generator 213 may determine that the second layer L103 and the fourth layer L107 from among the plurality of layers L101 to L109 are trace layers where traces are placed based on stackup distribution SUD. That is, routing data generator 213 may determine that the first layer TL1 of FIG. 6 as the second layer L103, and the second layer TL3 as the fourth layer L105. Additionally, the routing data generator 213 may determine that the third layer L105 disposed between the second and fourth trace layers L103 and L107 is a reference layer.

The routing data generator 213 may determine a first thickness T74 between the first layer L101 and the second layer L103, a second thickness T73 between the second layer L103 and the third layer L105, a third thickness T72 between the third layer L105 and the fourth layer L107, and a fourth thickness T71 between the fourth layer L107 and the fifth layer L109 based on the physical property information MPI. The resulting PCB model 700 may have a height of H1, as shown in FIG. 7.

The routing data generator 213 may determine a first dielectric disposed between the first layer L101 and the second layer L103, a second dielectric disposed between the second layer L103 and the third layer L105, a third dielectric disposed between the third layer L105 and the fourth layer L107, and a fourth dielectric disposed between the fourth layer L107 and the fifth layer L109 based on the physical property information MPI.

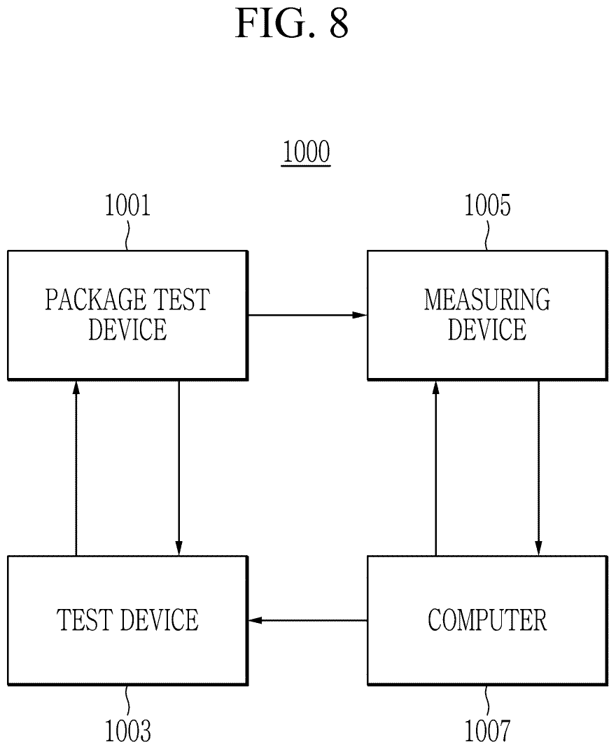

FIG. 8 is a block diagram illustrating a printed circuit board test system, according to an embodiment.

Referring to FIG. 8, a PCB test system 1000 may include a package test device 1001, a test device 1003, a measuring device 1005, and a computer 1007.

The package test device 1001 may be connected to the test device 1003. The package test device 1001 may perform operations based on the control of the test device 1003.

The measuring device 1005 may detect one or more signals of the test device 1003. The measuring device 1005 may measure signals transmitted from the test device 1003 to the package test device 1001 using a connector connected to the printed circuit board of the package test device 1001. For example, the measuring device 1005 may be an oscilloscope. The measuring device 1005 may receive a measurement signal from the package test device 1001 by measuring the signals transmitted by the test device 1003 to the package test device 1001. The measuring device 1005 may transmit a measuring signal to a computer 1007.

The computer 1007 may control the settings and operations of the test device 1003 and the measuring device 1005. The computer 1007 may analyze the measurement signal and detect internal defects in the test device 1003. In an embodiment, the computer 1007 may be a PCB design system as described using FIGS. 1 through 7. The computer 1007 may generate various geometries of traces that may be disposed within the PCB, and may place components based on the generated traces.

In an embodiment, each component or a combination of two or more components described with reference to FIGS. 1 through 8 may be implemented as a digital circuit, a programmable or non-programmable logic device or array, an application specific integrated circuit (ASIC), or the like.

Although the embodiments of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A printed circuit board design system, comprising:
one or more processors comprising processing circuitry; and
memory storing instructions,
wherein the instructions, when executed by the one or more processors individually or collectively, cause the printed circuit board design system to:
generate a canvas based on a length of a preset target trace;
determine an arbitrary start point and an arbitrary end point within the canvas;
randomly place a first obstacle having a first size within the canvas;
randomly place a second obstacle having a second size within the canvas, the second size being smaller than the first size;
generate a reference trace from the arbitrary start point to the arbitrary end point that avoids the first obstacle;
generate at least one variant trace from the arbitrary start point to the arbitrary end point that avoids the second obstacle; and
generate a candidate trace set comprising the reference trace and the at least one variant trace.

2. The printed circuit board design system of claim 1, wherein the instructions, when executed by the one or more processors individually or collectively, further cause the printed circuit board design system to:
generate, using a path search algorithm, the reference trace, based on an actual cost from the arbitrary start point to the arbitrary end point and an estimated cost from a current point to the arbitrary end point.

3. The printed circuit board design system of claim 1, wherein the instructions, when executed by the one or more processors individually or collectively, further cause the printed circuit board design system to:
generate, using a path search algorithm, the at least one variant trace, based on an actual cost from the arbitrary start point to the arbitrary end point, an estimated cost from a current point to the arbitrary end point, and a distance from the at least one variant trace to the reference trace.

4. The printed circuit board design system of claim 1, wherein the instructions, when executed by the one or more processors individually or collectively, further cause the printed circuit board design system to:
generate the reference trace based on preset trace conditions,
wherein the preset trace conditions comprise the length of the preset target trace and a number of the at least one variant trace comprised in the candidate trace set.

5. The printed circuit board design system of claim 1, wherein the instructions, when executed by the one or more processors individually or collectively, further cause the printed circuit board design system to:
determine a target number of candidate trace sets based on a topology of a structure of a printed circuit board;
determine whether a number of generated candidate trace sets satisfy the target number of candidate trace sets; and
generate at least one candidate trace set to satisfy the target number of candidate trace sets based on a determination that the number of generated candidate trace sets does not satisfy the target number of candidate trace sets.

6. The printed circuit board design system of claim 5, wherein the topology indicates a number of vias formed in the printed circuit board and a number of layers formed in the printed circuit board.

7. The printed circuit board design system of claim 5, wherein the instructions, when executed by the one or more processors individually or collectively, further cause the printed circuit board design system to:
scale the reference trace and the at least one variant trace based on a preset target trace length.

8. The printed circuit board design system of claim 7, wherein the printed circuit board comprises at least one layer,
wherein the instructions, when executed by the one or more processors individually or collectively, further cause the printed circuit board design system to generate routing data by combining the structure of the printed circuit board and the candidate trace set based on physical property information, and
wherein the physical property information comprises a dielectric characteristic disposed between the at least one layer and a thickness between the at least one layer.

9. A method for designing a printed circuit board, comprising:
generating a candidate trace set comprising a reference trace and at least one variant trace corresponding to the reference trace;
determining a target number of candidate trace sets based on a topology of a structure of the printed circuit board, the printed circuit board comprising at least one layer;
determining whether a number of generated candidate trace sets satisfies the target number of candidate trace sets; and
based on determining that the number of generated candidate trace sets satisfies the target number of candidate trace sets, generating routing data for the printed circuit board, the routing data comprising the generated candidate trace sets to be disposed on the printed circuit board.

10. The method of claim 9, wherein the generating of the candidate trace set comprises:
generating a canvas based on a length of a preset target trace;
setting an arbitrary start point and an arbitrary end point within the canvas;
randomly placing a first obstacle having a first size within the canvas; and
generating the reference trace from the arbitrary start point to the arbitrary end point that avoids the first obstacle.

11. The method of claim 10, wherein the generating of the reference trace comprises:
generating the reference trace using a path search algorithm, based on an actual cost from the arbitrary start point to the arbitrary end point and an estimated cost from a current point to the arbitrary end point.

12. The method of claim 10, wherein the generating of the candidate trace set comprises:
randomly placing a second obstacle having a second size within the canvas, the second size being smaller than the first size; and
generating at least one variant trace from the arbitrary start point to the arbitrary end point that avoids the second obstacle.

13. The method of claim 12, wherein the generating of the at least one variant trace comprises:
generating the at least one variant trace based on a trace condition comprising a number of at least one variant trace comprised in the candidate trace set.

14. The method for designing a printed circuit board of claim 12, wherein the generating of the at least one variant trace comprises:
generating the at least one variant trace using a path search algorithm based on an actual cost from the arbitrary start point to the arbitrary end point, an estimated cost from a current point to the arbitrary end point, and a distance from the at least one variant trace to the reference trace.

15. The method of claim 9, wherein the determining of the target number of candidate trace sets comprises:
determining the target number of candidate trace sets based on the topology indicating a number of vias in the printed circuit board.

16. The method for designing a printed circuit board of claim 9, wherein the generating of the routing data comprises:
generating the routing data based on physical property information comprising a dielectric characteristic disposed between the at least one layer and a thickness between the at least one layer.

17. The method of claim 16, wherein the at least one layer comprises at least one trace layer and a reference layer, and
wherein the generating of the routing data comprises scaling the reference trace and the at least one variant trace based on a preset target trace length.

18. A method for designing a printed circuit board, comprising:
generating a canvas based on a length of a preset target trace;
setting an arbitrary start point and an arbitrary end point within the canvas;
randomly placing a first obstacle having a first size within the canvas;
generating a reference trace from the arbitrary start point to the arbitrary end point that avoids the first obstacle;
randomly placing a second obstacle having a second size within the canvas, the second size being smaller than the first size;
generating at least one variant trace from the arbitrary start point to the arbitrary end point that avoids the second obstacle; and
generating a candidate trace set comprising the reference trace and at least one variant trace.

19. The method of claim 18, wherein the generating of the candidate trace set comprises:
determining a target number of candidate trace sets based on a topology of a structure of the printed circuit board;
determining whether a number of generated candidate trace sets satisfies the target number of candidate trace sets; and
based on determining that the number of generated candidate trace sets does not satisfy the target number of candidate trace sets, generating at least one candidate trace set to satisfy the target number of candidate trace sets.

20. The method of claim 19, wherein the generating of the reference trace comprises:
generating the reference trace, using the path search algorithm, based on an actual cost from the arbitrary start point to the arbitrary end point and an estimated cost from a current point to the arbitrary end point, and
wherein the generating of the at least one variant trace comprises:
generating the at least one variant trace, using an A* algorithm, based on the actual cost from the arbitrary start point to the arbitrary end point, the estimated cost from the current point to the arbitrary end point, and a distance from the at least one variant trace to the reference trace.
